(19) United States
(12) Patent Application Publication
(10) Pub. No.: US 2016/0263897 A1
(43) Pub. Date: Sep. 15, 2016

(54) LIQUID EJECTING APPARATUS

(71) Applicant: SEIKO EPSON CORPORATION, Tokyo (JP)

(72) Inventors: Masaru KOBASHI, Matsumoto-shi (JP); Masahisa NAWANO, Suwa-shi (JP); Kazuhiko SATO, Matsumoto-shi (JP)

(21) Appl. No.: 15/049,440

(22) Filed: Feb. 22, 2016

(30) Foreign Application Priority Data
Mar. 13, 2015 (JP) 2015-050510

(51) Int. Cl. B41J 2/165

(52) U.S. Cl. CPC B41J 2/16532; B41J 2/16535

(57) ABSTRACT

A liquid ejecting apparatus includes a liquid ejecting head having a nozzle which ejects a liquid onto a medium, a wiping member that wipes the liquid which has adhered to a nozzle forming surface of the liquid ejecting head, a support member that supports the wiping member, moves the wiping member relative to the liquid ejecting head, and has a receiving portion receiving the liquid wiped by the wiping member, and a connection flow path that is capable of being connected to the support member, wherein the receiving portion and the connection flow path communicate with each other with movement of the support member.

### BACKGROUND

1. Technical Field

The present invention relates to a liquid ejecting apparatus.

2. Related Art

In general, an ink jet printer that ejects ink (liquid) onto a recording medium such as paper through nozzles of openings formed on a nozzle forming surface of a liquid ejecting head for printing has been known as one type of a liquid ejecting apparatus. The printer normally includes a head maintenance device for maintaining ink ejection characteristics from the liquid ejecting head.

Such head maintenance device has various functions.

For example, the head maintenance device has a function of recovering the ink ejection characteristics through the nozzles by capping the nozzle forming surface of the liquid ejecting head by a suction cap and sucking thickened ink from the nozzles by a suction pump. Further, the head maintenance device has a function of wiping unnecessary ink that has adhered to the nozzle forming surface of the liquid ejecting head by a wiper.

Japanese Patent No. 5279610 discloses a technique in which a discharge port opened to the lower side so as to penetrate through a cleaning unit base member is formed on a bottom wall portion of a wiper case. Ink removed from a nozzle surface by a wiper member is discharged to the outside of a wiper storage portion from the discharge port. However, this configuration has a problem that the ink received by a wiper support portion drips through the discharge port and soils an apparatus inner portion.

For example, a printer in which a line head is mounted includes an extremely large number of nozzles and an amount of ink that is removed by wiping is therefore large. In this case, an amount of ink that flows out into the apparatus is large and the soiling with ink is increased.

### SUMMARY

An advantage of some aspects of the invention is to provide a liquid ejecting apparatus capable of discharging liquid removed by wiping efficiently and preventing an apparatus inner portion from being soiled.

A liquid ejecting apparatus according to an aspect of the invention includes a liquid ejecting head having a nozzle which ejects a liquid onto a medium, a wiping member that wipes the liquid which has adhered to a nozzle surface of the liquid ejecting head, a support member that supports the wiping member, moves the wiping member relative to the liquid ejecting head, and has a receiving portion receiving the liquid which is wiped by the wiping member, and a connection flow path that is capable of being connected to the support member, wherein the receiving portion and the connection flow path communicate with each other with movement of the support member.

With this configuration, the receiving portion and the connection flow path are connected to each other so that the liquid in the receiving portion can be discharged to the outside of the receiving portion through the connection flow path. This can suppress the overflow of the liquid received by the receiving portion from the receiving portion and the soiling in an apparatus inner portion.

In the liquid ejecting apparatus according to an aspect of the invention, it is preferable that a suction unit communicating with the connection flow path be further provided, and the liquid in the receiving portion be discharged to an outside of the receiving portion through the connection flow path by suction by the suction unit.

With this configuration, the liquid in the receiving portion can be discharged more reliably with suction force by the suction unit.

In the liquid ejecting apparatus according to an aspect of the invention, it is preferable that the connection flow path have an insertion portion extending toward the support member, and a valve capable of opening a space communicating with the receiving portion when the support member is connected with the insertion portion be provided on the support member at a position opposing the connection flow path.

This configuration does not require any other force for connecting the receiving portion of the support member and the connection flow path.

In the liquid ejecting apparatus according to an aspect of the invention, it is preferable that the space communicate with a lower portion of the receiving portion.

This configuration can suppress liquid from remaining in the receiving portion.

In the liquid ejecting apparatus according to an aspect of the invention, it is preferable that a transportation unit transporting the medium be further provided, and the connection flow path be provided at an outside of a transportation region of the medium.

With this configuration, dripping of the liquid to the transportation unit can be suppressed when the receiving portion and the connection flow path are connected to each other.

In the liquid ejecting apparatus according to an aspect of the invention, it is preferable that a waste liquid storage portion in which the liquid discharged by the suction unit is stored be provided.

With this configuration, the liquid discharged from the receiving portion is stored in the waste liquid storage portion, thereby suppressing the soil in the apparatus inner portion with the liquid.

In the liquid ejecting apparatus according to an aspect of the invention, it is preferable that a cap forming a closed space including an opening of the nozzle be further provided, and the suction unit communicate with an inner portion of the cap and cause the liquid to be discharged from the nozzle through the closed space.

With this configuration, the common suction unit can be used in a nozzle cleaning operation of the liquid ejecting head and a wiping operation on the nozzle surface by the wiping member. Further, the liquid discharged by the respective operations can be stored in the common waste liquid storage portion.

### BRIEF DESCRIPTION OF THE DRAWINGS

The invention will be described with reference to the accompanying drawings, wherein like numbers reference like elements.

FIG. 1 is a view illustrating the schematic configuration of a liquid ejecting apparatus.

FIG. 2 is a view illustrating the schematic configuration of the liquid ejecting apparatus when seen from an arrow S side in FIG. 1.

FIG. 3 is a view illustrating a positional relation between a liquid ejecting head and a wiping mechanism in the liquid ejecting apparatus.

FIG. 4 is a view illustrating the schematic configuration of the wiping mechanism and a liquid discharge mechanism.

FIG. 5 is a view illustrating the configuration of the liquid ejecting head.

FIG. 6 is a view illustrating the configuration of the liquid ejecting head.

FIG. 7 is a view illustrating the electric configuration of a controller that is included in the liquid ejecting apparatus.

FIG. 8 is a view for explaining a printing processing operation on a medium.

FIG. 9 is a view for explaining nozzle cleaning for eliminating ejection failure of the liquid ejecting head.

FIG. 10 is a view illustrating a capping state on a nozzle forming surface.

FIG. 11 is a view for explaining wiping processing on the nozzle forming surface.

FIGS. 12A and 12B are views for explaining the wiping processing on the nozzle forming surface, FIG. 12A is a view illustrating a wiping processing operation and FIG. 12B is a view illustrating an ink suction operation.

### DESCRIPTION OF EXEMPLARY EMBODIMENTS

Hereinafter, one embodiment of a liquid ejecting apparatus will be described with reference to the drawings.

The liquid ejecting apparatus is an ink jet printer that ejects ink (liquid) as an example of liquid onto a medium such as paper, for example, so as to perform printing on the medium.

In the individual drawings, an X direction is a movement direction of a wiper carriage, a Y direction is a transportation direction of the medium, and a Z direction is a direction orthogonal to the X direction and the Y direction.

### Liquid Ejecting Apparatus

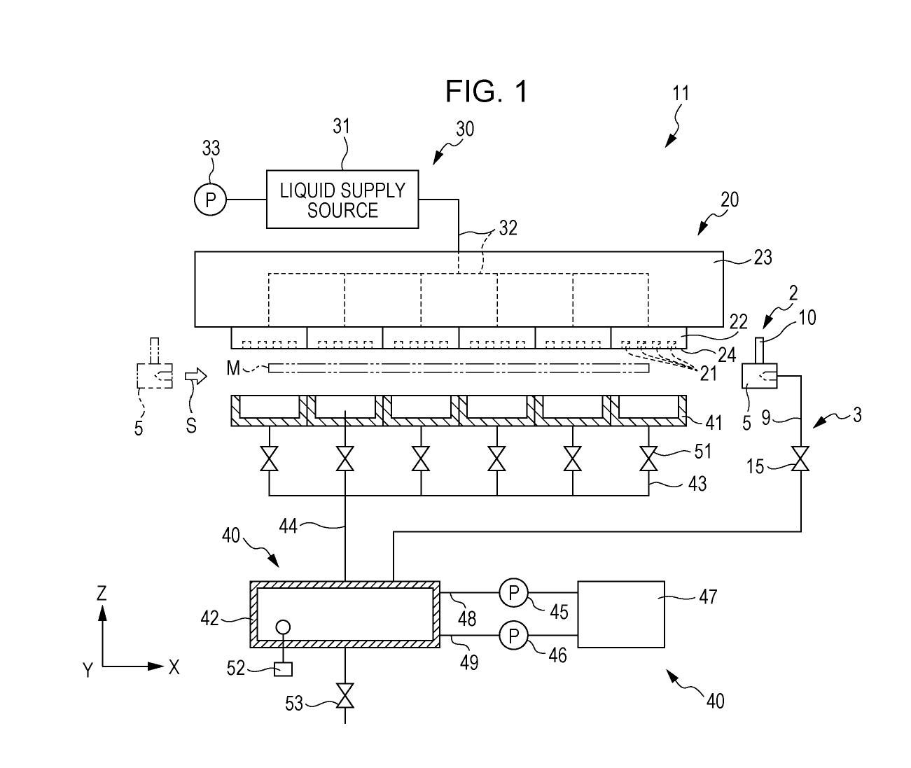

FIG. 1 is a view illustrating the schematic configuration of the liquid ejecting apparatus.

As illustrated in FIG. 1, a liquid ejecting apparatus 11 includes a liquid ejecting unit 20, a liquid supply unit 30, and a maintenance unit 40. The liquid ejecting unit 20 ejects ink (liquid) onto a medium M. The liquid supply unit 30 supplies the ink to the liquid ejecting unit 20. The maintenance unit 40 performs maintenance of the liquid ejecting unit 20.

The liquid ejecting unit 20 includes a plurality of (six in the embodiment) liquid ejecting heads 22 on which a plurality of nozzles 21 are formed and a support portion 23 supporting the plurality of liquid ejecting heads 22. In the embodiment, the plurality of nozzles 21 formed on the liquid ejecting heads 22 correspond to an example of a “nozzle group”. The plurality of liquid ejecting heads 22 are arranged in parallel in a width direction (X direction in FIG. 1) of the medium M, which intersects with a transportation direction (Y direction orthogonal to a paper plane in FIG. 1) of the medium M.

It should be noted that although the drawing is simplified in FIG. 1 for making explanation be understood easily, when the nozzles 21 of the respective liquid ejecting heads 22 are projected in the transportation direction of the medium M, the projected nozzles 21 of the liquid ejecting heads 22 are arranged at a constant interval in the width direction of the medium M.

The liquid supply unit 30 includes a liquid supply source 31, a supply flow path 32, and a pressure pump 33. The liquid supply source 31 stores therein the ink that is supplied to the liquid ejecting unit 20. The supply flow path 32 connects the liquid supply source 31 and the liquid ejecting unit 20. The pressure pump 33 is connected to the liquid supply source 31 and supplies the ink stored in the liquid supply source 31 to the liquid ejecting unit 20 in a pressurizing manner.

The liquid supply source 31 may be a liquid cartridge that is detachably mounted on the liquid ejecting apparatus 11 or may be a liquid storage tank that is provided in the liquid ejecting apparatus 11. The supply flow path 32 can supply the liquid to the liquid ejecting unit 20 from the liquid supply source 31 by driving of the pressure pump 33.

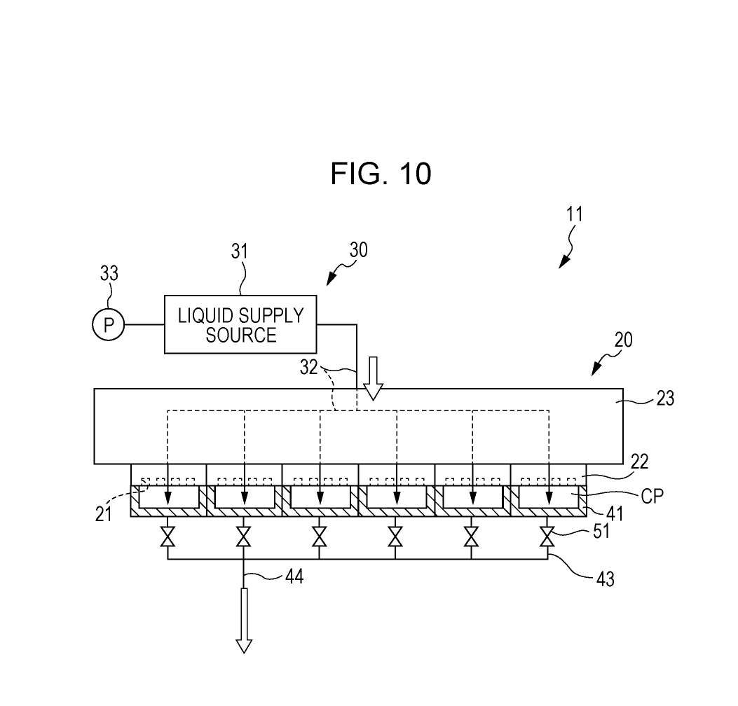

The maintenance unit 40 includes caps 41, a buffer tank 42, a plurality of branch flow paths 43, and a converging flow path 44. The caps 41 make spaces including openings of the nozzles 21 of the liquid ejecting heads 22 be closed spaces CP (see FIG. 10). The buffer tank 42 can store therein fluid (air mainly) depressurized to a pressure lower than the atmospheric pressure. One side ends of the branch flow paths 43 are connected to the respective caps 41. The converging flow path 44 connects the other ends of the branch flow paths 43 and the buffer tank 42.

The maintenance unit 40 includes a first depressurizing pump (suction unit) 45 and a second depressurizing pump (suction unit) 46 depressurizing the buffer tank 42, a waste liquid storage portion 47, and a first flow path 48 and a second flow path 49. The waste liquid storage portion 47 stores therein the ink that has flowed out from the nozzles 21 of the liquid ejecting heads 22. The first flow path 48 and the second flow path 49 connect the buffer tank 42 and the waste liquid storage portion 47.

Each cap 41 has a box shape with a bottom and can be moved relatively to a nozzle forming surface 24 of each liquid ejecting head 22. The cap 41 is moved in the direction of making close to the liquid ejecting head 22 and makes contact with the nozzle forming surface 24 so that the above-mentioned closed space CP is formed. In the embodiment, the cap 41 making contact with the nozzle forming surface 24 so as to form the closed space CP is referred to as “capping” and the cap 41 being separated from the nozzle forming surface 24 so as to open the closed space CP is referred to as “uncapping”.

First open/close valves 51 permitting and limiting flowing of the fluid in the branch flow paths 43 are provided on the branch flow paths 43. Therefore, when the caps 41 cap the liquid ejecting heads 22, if the first open/close valves 51 are opened, the closed spaces CP and the buffer tank 42 are made into a communicating state through the branch flow paths 43 and the converging flow path 44.

On the other hand, when the caps 41 cap the liquid ejecting heads 22, if the first open/close valves 51 are closed, the closed spaces CP and the buffer tank 42 are made into a non-communicating state. Further, the first open/close valves 51 can be individually operated to be opened and closed. Therefore, when only the specific first open/close valve 51 is opened, only the specific closed space CP corresponding to the first open/close valve 51 can be made into the communicating state with the buffer tank 42.

It should be noted that the other ends of the branch flow paths 43 may be connected to the buffer tank 42 without providing the converging flow path 44.

A pressure sensor 52 and an atmosphere open valve 53 are provided on the buffer tank 42. The pressure sensor 52 measures a pressure in the buffer tank 42. The atmosphere open valve 53 opens the buffer tank 42 to the atmosphere. When the atmosphere open valve 53 is opened, it causes the buffer tank 42 and the atmosphere to be made into a communicating state. When the atmosphere open valve 53 is closed, it causes the buffer tank 42 and the atmosphere to be made into non-communicating state. Therefore, when the first depressurizing pump 45 and the second depressurizing pump 46 are driven in a state in which the first open/close valves 51 and the atmosphere open valve 53 are closed, the buffer tank 42 is depressurized to a pressure (negative pressure) of lower than the atmospheric pressure. Further, when the arbitrary first open/close valve 51 is opened in a state in which the liquid ejecting heads 22 are capped and the buffer tank 42 is depressurized to the pressure lower than the atmospheric pressure, the corresponding closed space CP that is made to communicate with the buffer tank 42 is rapidly depressurized.

The first depressurizing pump 45 is provided on the first flow path 48 and depressurizes the buffer tank 42 through the first flow path 48. Further, the second depressurizing pump 46 is provided on the second flow path 49 and depressurizes the buffer tank 42 through the second flow path 49.

As an example, a depressurizing amount by the first depressurizing pump 45 may be set to be larger than a depressurizing amount by the second depressurizing pump 46 by using a diaphragm pump for the first depressurizing pump 45 and using a rotary pump for the second depressurizing pump 46. It should be noted that only one depressurizing pump may be provided.

The maintenance unit 40 further includes a wiping mechanism 2 and a liquid discharge mechanism 3. The wiping mechanism 2 performs wiping processing on the nozzle forming surfaces 24 of the liquid ejecting heads 22. The liquid discharge mechanism 3 discharges the ink removed by the wiping mechanism 2 into the waste liquid storage portion 47.

The wiping mechanism 2 includes a wiper member (wiping member) 10 and a wiper carriage (support member) 5 supporting the wiper member 10, and wipes the nozzle forming surfaces 24 by the wiper member 10 with the movement of the wiper carriage 5 in the X direction.

The liquid discharge mechanism 3 includes a connection flow path 9 that can be connected to the wiper carriage 5 and an open/close valve 15 that is provided on the connection flow path 9. The downstream side of the connection flow path 9 is connected to the buffer tank 42 and the ink removed by the wiper member 10 can be therefore discharged into the buffer tank 42.

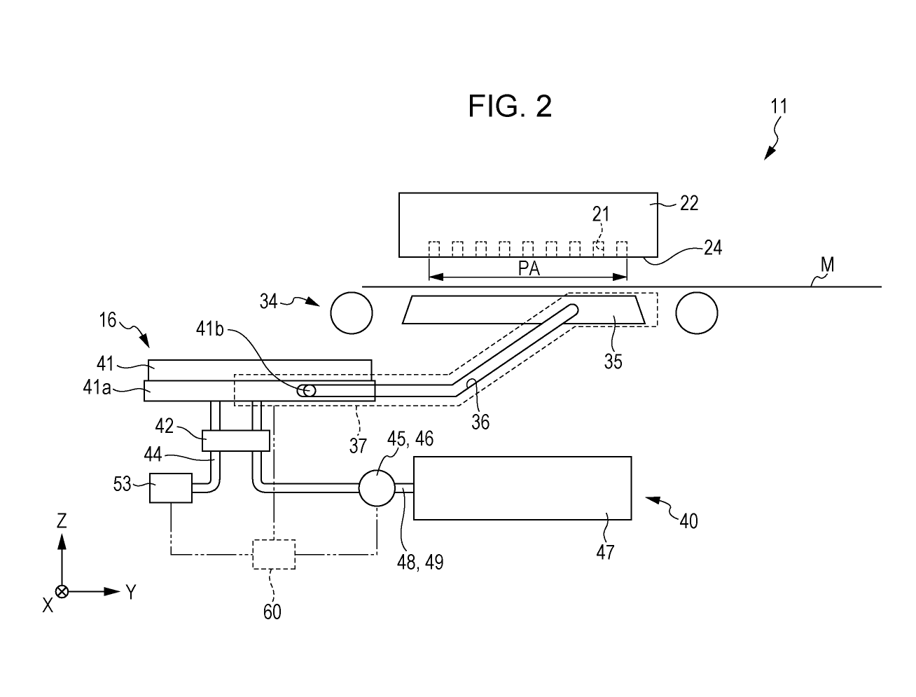

FIG. 2 is a view illustrating the schematic configuration of the liquid ejecting apparatus when seen from an arrow S side in FIG. 1. It should be noted that a platen is omitted in FIG. 1.

As illustrated in FIG. 2, the liquid ejecting apparatus 11 further includes a platen 35 for supporting the medium M and a medium transportation mechanism (transportation unit) 34 for transporting the medium M in the transportation direction Y.

The medium transportation mechanism 34 includes transportation rollers 18 and 19 that are arranged at the upstream side and the downstream side of a print region PA in the transportation direction Y, for example.

It should be noted that the medium transportation mechanism 34 may include a transportation belt on which the medium M is capable of being placed.

The liquid ejecting heads 22 eject liquid droplets onto the medium M that is transported by the medium transportation mechanism 34 through the nozzles 21 on the print region PA so as to perform printing.

The platen 35 is configured so as to move between a position at which it opposes the nozzle forming surfaces 24 of the liquid ejecting heads 22 and supports the medium M and a position at which it does not oppose the nozzle forming surfaces 24. The platen 35 may be configured to move in conjunction with the movement of the caps 41 in a cap movement mechanism 37, which will be described later, or may be configured to be controlled by a controller 60.

The maintenance unit 40 in the embodiment further includes the cap movement mechanism 37 for moving the caps 41 along the movement direction intersecting with the gravity direction Z through cap support members 41a. The cap movement mechanism 37 includes guide rails 36 guiding projections 41b provided on the cap support members 41a and move the caps 41 along the guide rails 36. The cap movement mechanism 37 is controlled by the controller 60.

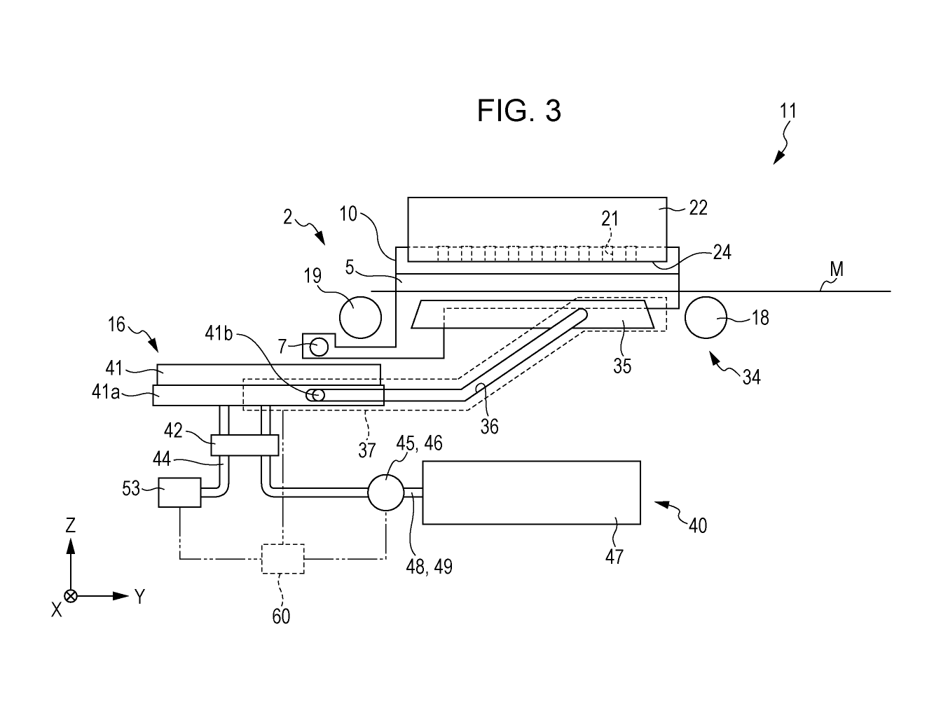

FIG. 3 is a view illustrating a positional relation between the liquid ejecting head and the wiping mechanism in the liquid ejecting apparatus.

As illustrated in FIG. 1 and FIG. 3, the wiping mechanism 2 is installed at a position at which a front end of the wiper member 10 in the Z direction is higher than the nozzle forming surfaces 24 of the liquid ejecting heads 22. A carriage shaft 7 extends in parallel with the transportation rollers 18 and 19 of the medium transportation mechanism 34.

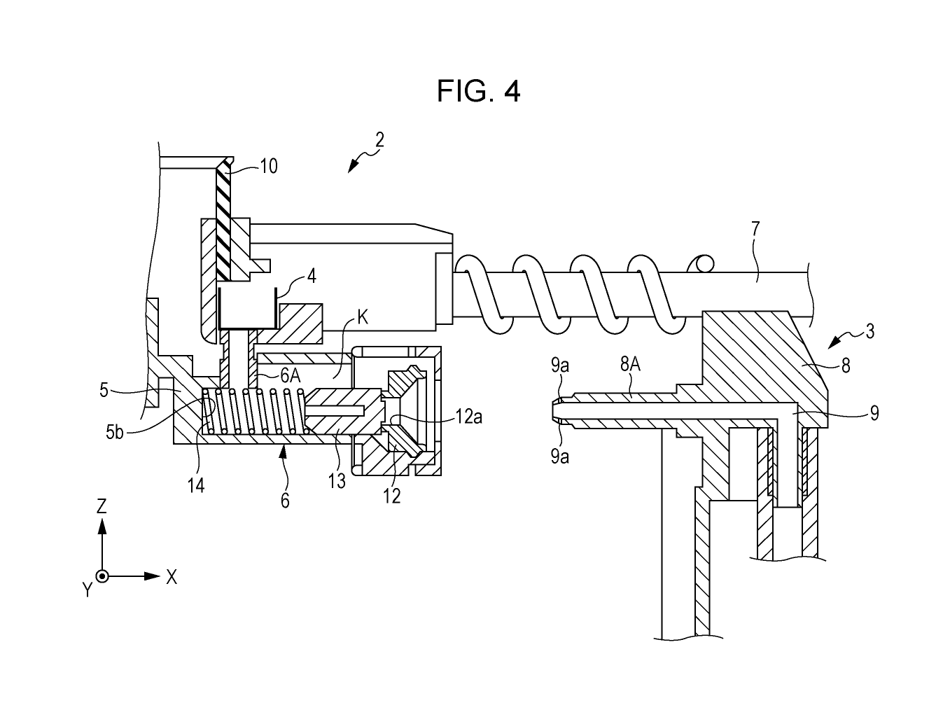

FIG. 4 is a view illustrating the schematic configuration of the wiping mechanism and the liquid discharge mechanism.

As illustrated in FIG. 4, the wiping mechanism 2 includes the wiper member 10 wiping the nozzle forming surfaces 24 of the liquid ejecting heads 22 and the wiper carriage 5 supporting the wiper member 10. The wiper carriage 5 includes an ink receiving portion (receiving portion) 4 that receives the ink removed by the wiper member 10 and a connection portion 6 to which the liquid discharge mechanism 3 is connected. The wiping mechanism 2 is configured so as to reciprocate along an axial direction (X direction) of the carriage shaft 7 attached to an apparatus main body while being guided by the carriage shaft 7.

### Wiping Mechanism

The wiper member 10 is made of a material having flexibility, for example, a resin material such as elastomer. Therefore, the wiper member 10 can make slide contact with the nozzle forming surfaces 24 in a flexible manner so as to preferably wipe the nozzle forming surfaces 24 and remove the ink.

The wiper carriage 5 is configured such that the ink receiving portion 4 and the connection portion (valve portion) 6 are included. The ink receiving portion 4 supports the wiper member 10 and receives the ink removed by the wiper member 10. The liquid discharge mechanism 3 is connected to the connection portion (valve portion) 6.

The ink receiving portion 4 has a predetermined volume capable of receiving the ink removed by the wiper member 10. The ink receiving portion 4 communicates with a space K of the connection portion 6 through an ink flow path 6A of the connection portion 6. The position of the ink receiving portion 4 is set in accordance with the wiping direction (X direction). The ink receiving portion 4 is provided at the front side in the wiping direction, that is, at a front-side position of the wiper member 10 in the direction in which the ink is wiped by the wiper member 10. With this configuration, the ink removed by the wiper member 10 can be received reliably.

The connection portion 6 includes an open/close valve 13 that is provided on the wiper carriage 5 at a position opposing the liquid discharge mechanism 3 and is opened only when the liquid discharge mechanism 3 is connected to the connection portion 6. The connection portion 6 further includes the ink flow path 6A, a seal member 12, and a spring member 14.

In the embodiment, the connection portion 6 is made to communicate with the lower portion of the ink receiving portion 4 so that the ink receiving portion 4 can be made to communicate with the connection flow path 9, which will be described later, through the space K and the ink flow path 6A. In addition, an effect of suppressing the ink from remaining in the ink receiving portion 4 can be obtained by making the connection portion 6 communicate with the lower portion of the ink receiving portion 4.

The seal member 12 has an insertion hole 12a into which an insertion portion 8A provided on a connection-side frame 8 of the liquid discharge mechanism 3 can be inserted. The seal member 12 is configured by an elastic member and desirably has high adhesion property to the insertion portion 8A.

The open/close valve 13 permits and limits flow of the ink into the connection flow path 9 through the ink flow path 6A from the ink receiving portion 4 and is biased to the seal member 12 side by the spring member 14 all the time. In a state in which the insertion portion 8A of the connection-side frame 8 is not inserted, the open/close valve 13 is made to abut against the seal member 12 by biasing force of the spring member 14 so as to close the insertion hole 12a of the seal member 12.

The spring member 14 is arranged between a wall portion 5b of the wiper carriage 5 and the open/close valve 13 and biases the open/close valve 13 to the seal member 12 side all the time.

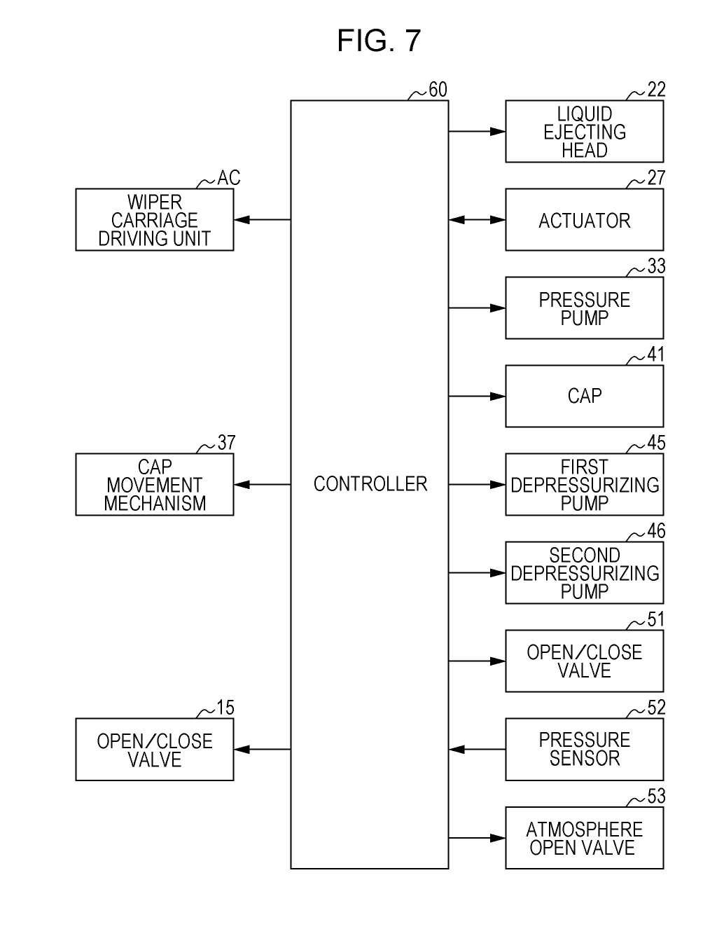

The wiper carriage 5 moves the wiper member 10 relative to the liquid ejecting heads 22 as illustrated in FIG. 1. The wiper carriage 5 is connected to a wiper carriage driving unit AC (FIG. 7) including a motor mechanism or the like, for example, and is moved by an operation of the wiper carriage driving unit AC. A movement amount and a movement timing of the wiper carriage 5 by the wiper carriage driving unit AC are controlled by the controller 60, for example.

### Liquid Discharge Mechanism

As illustrated in FIG. 4, the liquid discharge mechanism 3 includes the connection-side frame 8 having the insertion portion 8A that can be inserted into the wiper carriage 5, the connection flow path 9 formed in the connection-side frame 8, and the open/close valve 15 (FIG. 1) provided on the connection flow path 9. The liquid discharge mechanism 3 is fixed to one end side on a movement path of the wiper carriage 5, that is, one end side of the carriage shaft 7, and can be connected to the moved wiping mechanism 2.

The liquid discharge mechanism 3 is provided at the outside of a transportation region of the medium M and is connected to the wiping mechanism 2 at an outside position of the transportation region of the medium M.

The insertion portion 8A provided on the connection-side frame 8 is formed so as to extend toward the wiper carriage 5 in the X direction. A plurality of suction flow paths 9a communicating with the connection flow path 9 are formed on the insertion portion 8A at the tapered front end side. The suction flow paths 9a extend in the direction perpendicular to the connection flow path 9 and are formed by flow paths thinner than the connection flow path 9. The number of suction flow paths 9a and the diameter of the flow paths can be changed appropriately. The downstream side of the connection flow path 9 provided in the connection-side frame 8 is connected to the buffer tank 42 as illustrated in FIG. 1.

The open/close valve 15 as illustrated in FIG. 1 permits and limits flow of the ink in the connection flow path 9. When the open/close valve 15 is opened, the ink receiving portion 4 in the wiper carriage 5 and the buffer tank 42 can be made into a communicating state through the connection flow path 9.

### Liquid Ejecting Head

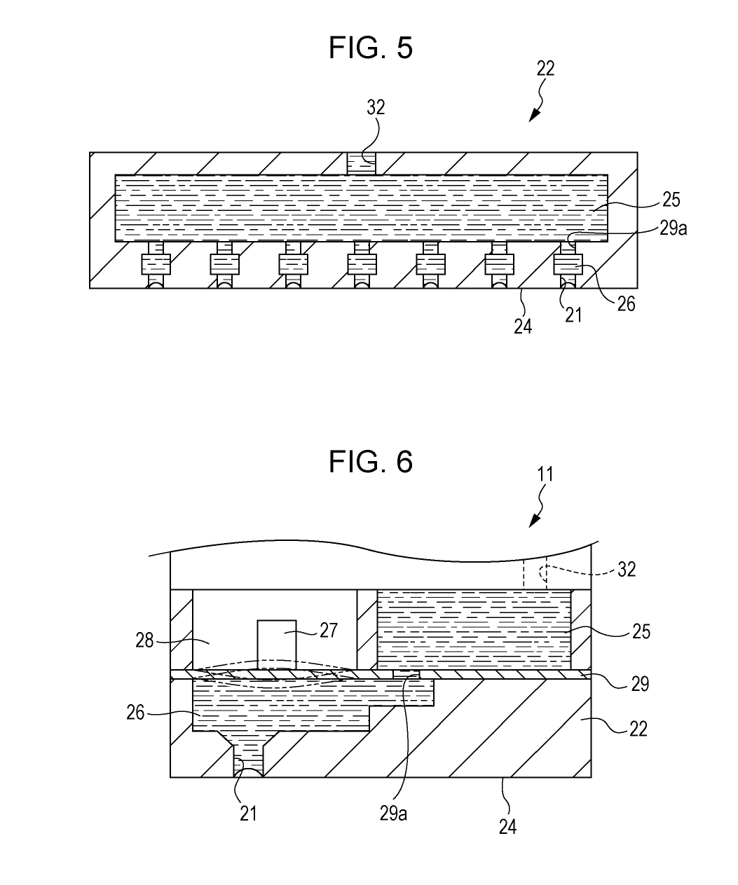

Next, the configuration of each liquid ejecting head 22 will be described in detail with reference to FIG. 5 and FIG. 6. FIG. 6 is a view schematically illustrating a cross section of the liquid ejecting head 22, which intersects with the nozzle row direction (right-left direction in FIG. 5) of the liquid ejecting head 22 as illustrated in FIG. 5.

As illustrated in FIG. 5 and FIG. 6, the liquid ejecting head 22 includes a common liquid chamber 25, liquid chambers 26, actuators 27, and storage chambers 28 in addition to the plurality of nozzles 21. The common liquid chamber 25 stores therein liquid supplied through the supply flow path 32. The volumes of the liquid chambers 26 can be changed. The actuators 27 are driven when the liquid is ejected through the nozzles 21. The storage chambers 28 store therein the actuators 27. The common liquid chamber 25 is provided for the plurality of nozzles 21 while the liquid chamber 26, the storage chamber 28, and the actuator 27 are provided for the single nozzle 21.

As illustrated in FIG. 6, the common liquid chamber 25, the storage chambers 28 and the liquid chambers 26 are partitioned by a vibration plate 29 that can be elastically deformed. Further, the common liquid chamber 25 and the liquid chambers 26 communicate with each other through communication holes 29a formed on the vibration plate 29. Therefore, the liquid supplied from the liquid supply source 31 through the supply flow path 32 is temporarily stored in the common liquid chamber 25, and then, is supplied to the respective nozzles 21 through the communication holes 29a and the liquid chambers 26 from the common liquid chamber 25.

The actuators 27 are piezoelectric elements that contract when a driving voltage is applied thereto, for example. Therefore, when the driving voltage that is applied to the actuators 27 is changed, the vibration plate 29 is deformed as indicated by a dashed-two dotted line in FIG. 6 and the volumes of the liquid chambers 26 change. With this, the liquid in the liquid chambers 26 is ejected through the nozzles 21 as liquid droplets.

### Controller

Next, the electric configuration of the controller 60 included in the liquid ejecting apparatus 11 will be described with reference to FIG. 7.

As illustrated in FIG. 7, the actuators 27 and the pressure sensor 52 are connected to an input-side interface of the controller 60. On the other hand, the liquid ejecting heads 22, the actuators 27, the pressure pump 33, the caps 41, the first depressurizing pump 45, the second depressurizing pump 46, the first open/close valves 51, and the atmosphere open valve 53 are connected to an output-side interface of the controller 60. The wiper carriage driving unit AC and the cap movement mechanism 37 are further connected to the controller 60.

The controller 60 controls to operate the cap movement mechanism 37 so that the nozzle forming surfaces 24 of the liquid ejecting heads 22 are capped with the caps 41 or uncapped.

Further, the controller 60 controls to operate the respective constituent components connected to the output-side interface thereof based on output signals from the actuators 27 and the pressure sensor 52 so as to perform nozzle cleaning for eliminating ejection failure of the liquid ejecting heads 22.

Further, the controller 60 controls to operate the wiper carriage 5 and the open/close valve 15 based on output signals from the liquid ejecting heads 22 and the cap movement mechanism 37 so as to perform wiping processing on the nozzle forming surfaces 24 of the liquid ejecting heads 22.

Next, respective operations of the liquid ejecting apparatus 11 will be described.

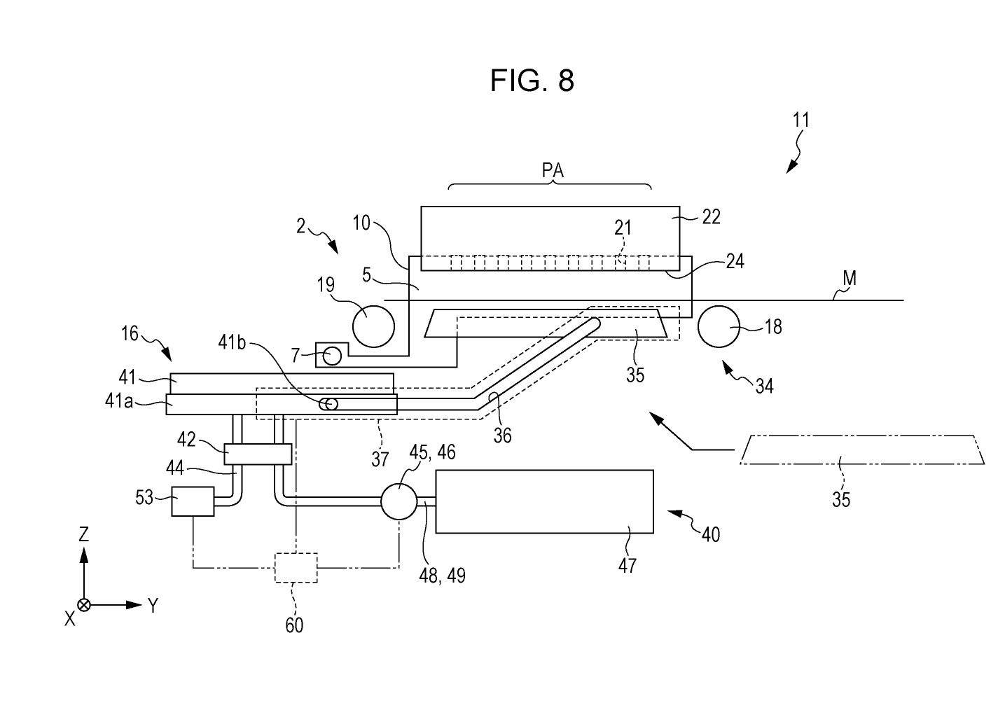

FIG. 8 is a view for explaining a printing processing operation on the medium.

When the controller 60 starts printing processing or the cap movement mechanism 37 moves the caps 41 to standby positions (position as indicated by a solid line in FIG. 8), as illustrated in FIG. 8, the platen 35 arranged at a retreat position (position as indicated by a dashed-two dotted line in FIG. 8) separated from the print region PA moves to a support position (position as indicated by a solid line in FIG. 8) set in the print region PA.

After the platen 35 moves to the support position, the medium M is transported to the print region PA and the printing processing by the liquid ejecting heads 22 is started on the medium M supported by the platen 35.

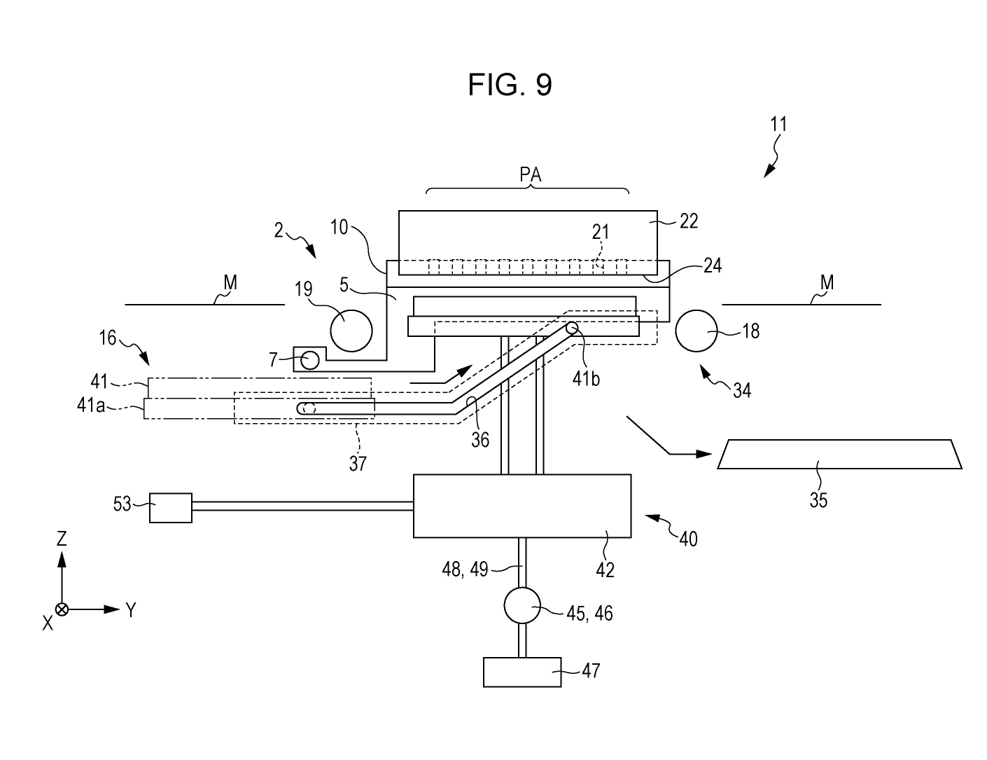

FIG. 9 is a view for explaining nozzle cleaning for eliminating ejection failure of the liquid ejecting head.

When the controller 60 determines that the nozzle cleaning for the liquid ejecting heads 22 is necessary, the caps 41 arranged at the standby positions (position as indicated by a dashed-two dotted line in FIG. 9) are moved to receiving positions (position as indicated by a solid line in FIG. 9). At this time, the platen 35 is moved to the retreat position (position as indicated by a solid line in FIG. 9) in conjunction with the movement of the caps 41.

To be specific, as illustrated in FIG. 10, the liquid ejecting head 22 as a maintenance target is capped with the cap 41 and the closed space CP is formed. Then, the closed space CP is depressurized so that the liquid and foreign matters such as air bubbles are discharged from the nozzles 21 of the liquid ejecting head 22. In this manner, the ejection failure of defect nozzles is eliminated.

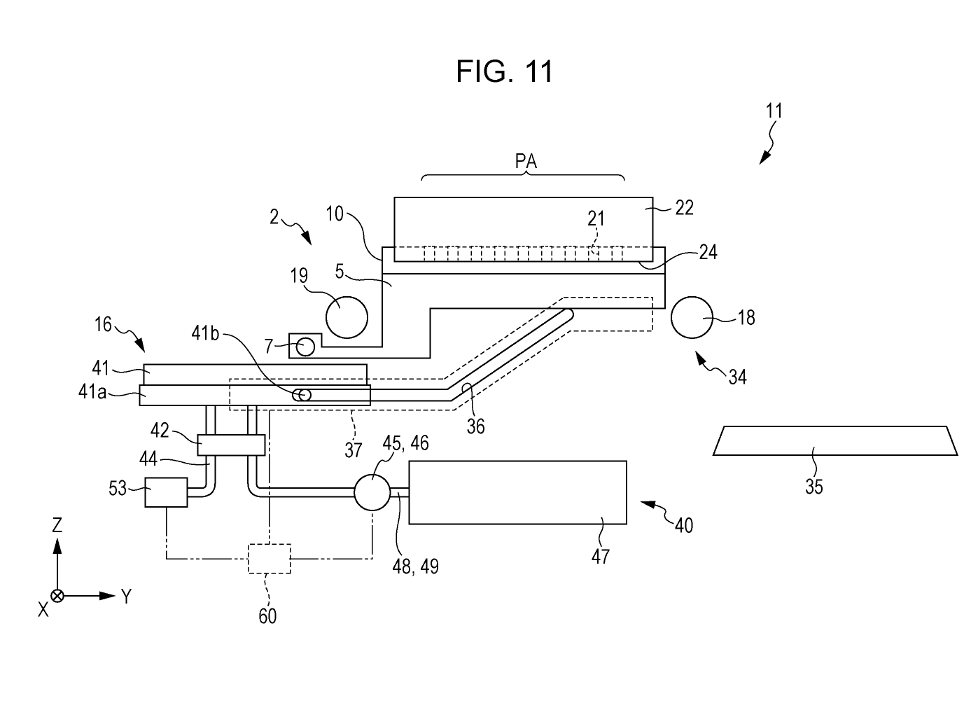

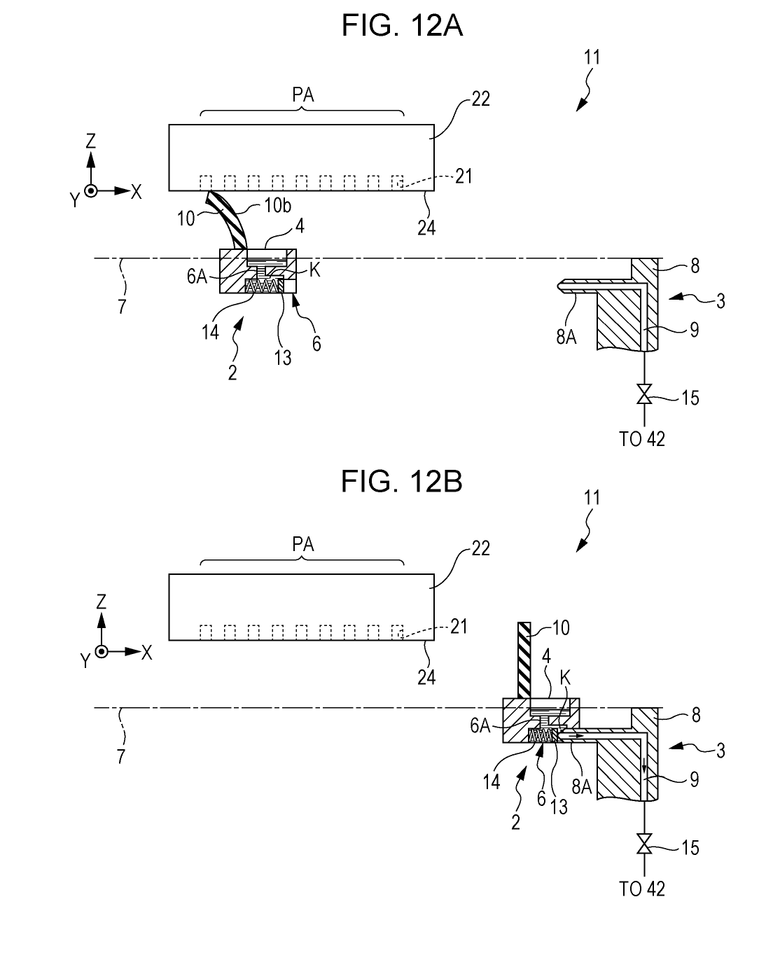

FIG. 11 and FIGS. 12A and 12B are views for explaining wiping processing on the nozzle forming surface. FIG. 12A is a view illustrating a wiping processing operation and FIG. 12B is a view illustrating an ink suction operation.

After the printing processing has been finished or the nozzle cleaning has been finished, the controller 60 executes the wiping processing on the nozzle forming surfaces 24 of the liquid ejecting heads 22.

The wiping processing is executed in a state in which the platen 35 and the caps 41 are moved to the respective retreat positions (positions as indicated by solid lines in FIG. 11).

First, the wiper carriage 5 located at a standby position (position as indicated by a solid line in FIG. 1) is moved to a standby position (position as indicated by a dashed-two dotted line in FIG. 1). Then, as illustrated in FIG. 11 and FIG. 12A, the wiper carriage 5 is moved in the X direction and causes the wiper member 10 to wipe the nozzle forming surfaces 24 so as to remove foreign matters that have adhered to the nozzle forming surfaces 24. The wiper member 10 makes slide contact with the nozzle forming surfaces 24 in a state of being elastically deformed (curved) relative thereto.

The ink removed by the wiper member 10 flows down a side surface 10b of the wiper member 10 and flows into the ink receiving portion 4. After the wiping processing is executed by moving the wiper carriage 5 in the +X direction, the wiper carriage 5 is moved to the outside of the transportation region (print region PA) of the medium M and the wiping mechanism 2 is connected to the liquid discharge mechanism 3 provided at the +X end side of the carriage shaft 7.

At this time, when the insertion portion 8A provided on the connection-side frame 8 of the liquid discharge mechanism 3 is inserted into the connection portion 6 of the wiper carriage 5, the insertion portion 8A presses the open/close valve 13 and the open/close valve 13 is moved against the biasing force by the spring member 14. In this manner, the open/close valve 13 is made an open state and the space K communicating with the ink receiving portion 4 is opened. In the embodiment, before the open/close valve 13 is made the open state, that is, before the wiping mechanism 2 and the liquid discharge mechanism 3 are connected, the first depressurizing pump 45 and the second depressurizing pump 46 as illustrated in FIG. 11 are driven so as to depressurize the buffer tank 42.

Timing at which the open/close valve 15 provided on the connection flow path 9 is opened and closed can be set appropriately.

When the open/close valve 15 and the open/close valve 13 are opened in the state in which the buffer tank 42 is depressurized, the ink flows out into the space K through the ink flow path 6A from the ink receiving portion 4 and is sucked from the plurality of suction flow paths 9a provided on the front end of the insertion portion 8A. The sucked ink flows into the buffer tank 42 through the connection flow path 9. The ink that has flowed into the buffer tank 42 is discharged to the waste liquid storage portion 47 by continuing driving of the first depressurizing pump 45 and the second depressurizing pump 46.

In the liquid ejecting apparatus 11 in the embodiment, after the wiping processing is finished, the ink removed by the wiping processing is discharged to the waste liquid storage portion 47 through the liquid discharge mechanism 3 from the wiping mechanism 2 by connecting the wiping mechanism 2 to the liquid discharge mechanism 3. With this, the ink removed by the wiper member 10 does not overflow from the ink receiving portion 4, thereby preventing the soil in an apparatus inner portion with the ink that has overflown from the ink receiving portion 4.

Further, the ink received by the ink receiving portion 4 can be discharged to the waste liquid storage portion 47 through the connection flow path 9 reliably because the suction forces of the first depressurizing pump 45 and the second depressurizing pump 46 are used.

As described above, the ink receiving portion 4 of the wiping mechanism 2 and the connection flow path 9 of the liquid discharge mechanism 3 communicate with each other with movement of the wiper carriage 5. Then, the connection portion 6 (open/close valve 13) provided on a portion of the wiper carriage 5, which opposes the liquid discharge mechanism 3, is opened only when the connection flow path 9 is connected thereto. This configuration does not require any other force for connecting the receiving portion 4 and the connection flow path 9.

After the wiping operation is finished, the wiping mechanism 2 is returned to the standby position as illustrated in FIG. 12B so as to be connected to the liquid discharge mechanism 3 and the ink receiving portion 4 and the connection flow path 9 communicate with each other. Therefore, time for discharging the ink can be shortened. That is to say, the controller 60 can execute a subsequent operation at a time point at which the wiping mechanism 2 has moved to the standby position. This enables time for the wiping processing to be shortened.

Further, the standby position of the wiping mechanism 2 is set to the position at the outside of the transportation path of the medium M. Therefore, when the ink receiving portion 4 and the connection flow path 9 are connected to each other, dripping of the ink to the medium M and the medium transportation mechanism 34 can be suppressed. In addition, the ink discharged from the ink receiving portion 4 is stored in the waste liquid storage portion 47 so as to prevent the soil in the apparatus inner portion with the ink.

In the embodiment, the ink removed by the wiping operation is sucked from the ink receiving portion 4 using the depressurizing pumps used for the nozzle cleaning operation and is discharged to the waste liquid storage portion 47. The ink discharged by the wiping operation is stored in the waste liquid storage portion 47 in which the ink discharged by the nozzle cleaning operation is stored. Thus, common constituent components are used for the operations, thereby suppressing increase in the apparatus size.

In the embodiment, the ink in the ink receiving portion 4 is not discharged to the connection flow path 9 during the wiping processing and the ink can be discharged to the connection flow path 9 only when the wiping mechanism 2 is connected to the liquid discharge mechanism 3.

Hereinbefore, the preferred embodiment according to the invention has been described with reference to the accompanying drawings. However, it is needless to say that the invention is not limited to the example. It is obvious that those skilled in the art can conceive various variations and modifications within a range of the technical spirit as described in the scope of the invention and it is understood that they also belong to the technical range of the invention. The configurations in the respective embodiments may be combined appropriately.

In the embodiment, the wiping processing is executed by moving the wiper member 10 in one direction. However, the invention is not limited thereto and the wiping processing may be executed by making the wiper member 10 reciprocate in the X direction. In this case, the ink receiving portion 4 is provided in the front-rear direction of the wiper member 10 in the wiping direction, thereby being able to receive the ink removed by the reciprocation of the wiper member 10 reliably.

The entire disclosure of Japanese Patent Application No. 2015-050510, filed Mar. 13, 2015 is expressly incorporated by reference herein.

What is claimed is:

1. A liquid ejecting apparatus comprising:
a liquid ejecting head having a nozzle which ejects a liquid onto a medium;
a wiping member that wipes the liquid which has adhered to a nozzle forming surface of the liquid ejecting head;
a support member that supports the wiping member, moves the wiping member relative to the liquid ejecting head, and has a receiving portion receiving the liquid which is wiped by the wiping member; and
a connection flow path that is capable of being connected to the support member,
wherein the receiving portion and the connection flow path communicate with each other with movement of the support member.

2. The liquid ejecting apparatus according to claim 1, further including a suction unit communicating with the connection flow path,
wherein the liquid in the receiving portion is discharged to an outside of the receiving portion through the connection flow path by suction by the suction unit.

3. The liquid ejecting apparatus according to claim 1,
wherein the connection flow path has an insertion portion extending toward the support member, and
a valve capable of opening a space communicating with the receiving portion when the support member is connected with the insertion portion is provided on the support member at a position opposing the connection flow path.

4. The liquid ejecting apparatus according to claim 3,
wherein the space communicates with a lower portion of the receiving portion.

5. The liquid ejecting apparatus according to claim 1, further including a transportation unit transporting the medium, where
in the connection flow path is provided at an outside of a transportation region of the medium.

6. The liquid ejecting apparatus according to claim 1,
wherein a waste liquid storage portion in which the liquid discharged by the suction unit is stored is provided.

7. The liquid ejecting apparatus according to claim 1, further being provided a cap which forms a closed space including an opening of the nozzle,
wherein the suction unit communicates with an inner portion of the cap and causes the liquid to be discharged from the nozzle through the closed space.
